(19) United States
(12) Patent Application Publication
(10) Pub. No.: US 2021/0323257 A1
(43) Pub. Date: Oct. 21, 2021

(54) PLASTIC STRUCTURES FOR OBFUSCATION OF SONAR SIGNATURE RETURNS AND RELATED TECHNIQUES

(71) Applicant: Massachusetts Institute of Technology, Cambridge, MA (US)

(72) Inventor: Cheryl O'Keefe, North Billerica, MA (US)

(21) Appl. No.: 17/218,835

(22) Filed: Mar. 31, 2021

Related U.S. Application Data
(60) Provisional application No. 63/012,461, filed on Apr. 20, 2020.

(51) Int. Cl. B29D 99/00; B33Y 80/00; G01S 7/521

(52) U.S. Cl. CPC B29D 99/0089; B33Y 70/00; G01S 7/521; B33Y 80/00

(57) ABSTRACT

Techniques are disclosed for modifying the acoustic signature of plastic structures. An example structure implementing the techniques includes an inner wall forming an inner shell of the structure, the inner wall having a first edge and a second edge opposing the first edge, and an outer wall forming an outer shell of the structure, the outer wall having a first edge and a second edge opposing the first edge. The structure also includes an upper wall member joining the first edge of the inner wall to the first edge of the outer wall and a lower wall member joining the second edge of the inner wall to the second edge of the outer wall to form a wall cavity, an infill structure within the wall cavity, and at least two holes in the structure providing an opening from an exterior of the structure to the wall cavity.

### CROSS REFERENCE TO RELATED APPLICATIONS

This application claims the benefit of U.S. Provisional Application 63/012,461 filed Apr. 20, 2020, the entire contents of which are incorporated by reference herein.

### STATEMENT REGARDING FEDERALLY SPONSORED RESEARCH

This invention was made with Government support under Grant No. FA8702-15-D-0001 awarded by the U.S. Air Force. The Government has certain rights in the invention.

### BACKGROUND

As is known, sound navigation and ranging (sonar) is a technique that uses sound propagation to navigate, communicate with, or detect objects on or under the surface of the water or a surrounding medium, such as other vessels. Two types of technology share the name “sonar,” passive sonar and active sonar. Passive sonar is essentially listening for the sound made by vessels or objects, whereas, active sonar includes emitting pulses of sound waves and listening for return signals generally referred to as echoes.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

The concepts, structures, and techniques described herein are directed toward modifying an acoustic signature of plastic objects, such as 3D printed objects. Such modification significantly reduces (and ideally eliminates) the acoustic signature produced by the plastic objects, thus enabling hiding, cloaking, and/or obfuscating of the plastic objects.

In accordance with one example embodiment provided to illustrate the broader concepts, structures, and techniques described herein, a structure includes an inner wall forming an inner shell of the structure, the inner wall having a first edge and a second edge opposing the first edge, and an outer wall forming an outer shell of the structure, the outer wall having a first edge and a second edge opposing the first edge. The structure also includes an upper wall member joining the first edge of the inner wall to the first edge of the outer wall and a lower wall member joining the second edge of the inner wall to the second edge of the outer wall to form a wall cavity, and an infill structure within the wall cavity. The structure further includes at least two holes in the structure providing an opening from an exterior of the structure to the wall cavity.

In one aspect, the structure is formed of a plastic material.

In one aspect, the structure is formed of a material having an acoustic impedance substantially similar to acoustic impedance of saltwater.

In one aspect, the material includes acrylonitrile butadiene styrene (ABS).

In one aspect, the material includes acrylonitrile styrene acrylate (ASA).

In one aspect, the material includes polylactic acid (PLA).

In one aspect, the material includes polyetherimide.

In one aspect, the infill structure includes a gyroid structure.

In one aspect, the infill structure includes a lattice structure.

In one aspect, the infill structure includes a channel structure.

In one aspect, the infill structure includes a honeycomb structure.

In one aspect, the at least two holes are two of a plurality of holes.

In one aspect, at least one hole of the at least two holes is in the upper wall member.

In one aspect, at least one hole of the at least two holes is in the lower wall member.

In one aspect, the structure also includes an extruded portion extending from the outer wall of the structure, the extruded portion having a cavity and an infill structure within the cavity.

In one aspect, the structure further includes at least two holes is in the extruded portion providing an opening from an exterior of the extruded portion to the cavity of the exterior portion.

In one aspect, the structure is a cylindrical structure having a base member sealing the second edge of the inner wall and forming a base of the cylindrical structure.

In one aspect, the structure is a 3D printed object

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments and concepts sought to be protected.

FIG. 1A depicts a perspective view of an example structure having a modified acoustic signature, in accordance with an embodiment of the present disclosure.

FIG. 1B depicts a cross-sectional view of a portion of a double-wall structure of the structure of FIG. 1A, in accordance with an embodiment of the present disclosure.

FIG. 2A depicts a perspective view of another example structure having a modified acoustic signature, in accordance with an embodiment of the present disclosure.

FIG. 2B depicts a cross-sectional view taken across line 2B-2B of the structure of FIG. 2A, in accordance with an embodiment of the present disclosure.

FIG. 3A depicts a perspective view of another example structure having a modified acoustic signature, in accordance with an embodiment of the present disclosure.

FIG. 3B depicts a perspective view of the structure of FIG. 3A having an upper wall member removed to reveal underlying structure, in accordance with an embodiment of the present disclosure.

FIG. 3C depicts a portion of a gyroid infill structure of the structure of FIG. 3A, in accordance with an embodiment of the present disclosure.

FIG. 4A depicts a perspective view of an example cylindrical structure having a modified acoustic signature, in accordance with an embodiment of the present disclosure.

FIG. 4B depicts another perspective view of the structure of FIG. 4A with additional details, in accordance with an embodiment of the present disclosure.

FIG. 4C depicts another perspective view of the structure of FIG. 4A with additional details. in accordance with an embodiment of the present disclosure.

FIG. 5 is a flow diagram of an example process for determining hole placement in a structure, in accordance with an embodiment of the present disclosure.

### DETAILED DESCRIPTION

As noted above, sonar is a technique for detecting underwater targets by acoustic means. Sound waves emitted by or reflected from an object are detected by a sonar apparatus and analyzed for the information they contain. For example, sonar may be used as a means of acoustic location and of measurement of the echo characteristics or signatures of objects (or “targets”) in the water or a surrounding medium.

With respect to manufacturing, advancements in additive manufacturing techniques as well as performance gains through the use of 3D printed objects have been well documented. For example, plastic additively manufactured objects have the potential benefits of shortened manufacturing time, weight reduction, and cost reduction. Additionally, 3D printing allows for easier integration of other materials or parts into the printed object creating a type of metamaterial. However, for the application of plastic additively manufactured objects in the undersea realm, this presents an unknown regarding how these plastic 3D printed objects respond to sonar interrogation.

A target's material composition and geometry are factors that may affect how identifiable targets are when identified (e.g., imaged or otherwise detected) using sonar.

Material density, density composition, and its interface with the surrounding water may also affect the target signature. An important parameter for this is acoustic impedance, which determines the amount of reflected, transmitted, or absorbed acoustic energy. Acoustic impedance, Z, can be calculated using the equation Z=ρc, where ρ is the density and c is the acoustic velocity. Using the speed of sound in 20C saltwater, which is equal to 1500 m/s, Table 1 below shows the density and specific acoustic impedance of various printable, plastic materials as well as aluminum and air for comparison.

TABLE 1

| | | Specific Acoustic | |
|---|---|---|---|
| | Density (kg/m³) | Impedance (kg/m²s) | Delta to Saltwater |
| Saltwater | 1030 | 1545000 | N/A |
| Freshwater | 1000 | 1480000 | −4% |
| ABS | 1040 | 1560000 | 1% |
| Ultem ® | 1270 | 1905000 | 23% |
| PLA | 1240 | 1860000 | 20% |
| ASA | 1070 | 1605000 | 4% |
| Al 6061 | 2700 | 4050000 | 162% |
| Air | 1.3 | 445.9 | −100% |

Table 1 shows that many of the plastics, such as acrylonitrile butadiene styrene (ABS) and acrylonitrile styrene acrylate (ASA), have a very close acoustic impedance as compared to saltwater. Other plastics, such as polylactic acid (PLA) and polyetherimide (Ultem®), while not as good as ABS and ASA, have acoustic impedance that is much closer to saltwater than that of aluminum.

With regard to 3D printed objects, approximately 20% of the interior of a 3D printed object typically contains structure of the same materials as the rest of the object. This means that when the objects are dry, the interior voids are filled with air. However, when immersed in water, the object becomes filled with water. As shown in Table 1, the acoustic impedance of air is significantly different as compared to both freshwater and saltwater. This would result in the object appearing as a bright return when under sonar interrogation. Due to the various densities of internal fills that are available when manufacturing 3D printed objects, it has been recognized that the difference in acoustic impedance can be overcome by increasing the transmissivity of the 3D printed object.

The target strength depends on the impedance contrast between the mediums (for example, saltwater vs air). The acoustic impedance depends on the material acoustic properties (which are inherent to each material). These properties and the difference between the two materials at their interface determine the amounts of the sound wave that is reflected, transmitted, or absorbed. The closer the match of the two acoustic impedances, the higher the transmissivity. As an example, this difference is why air in water (e.g., trapped in a part or just as a bubble) has such a large reflectance under sonar interrogation.

For example, in the realm of fishing, sonar can be used to detect large fish or schools of smaller fish by identifying their swim bladders. The different density of the air within the swim bladder and the surrounding tissue and water results in different signal returns (or feedback) allowing the fish to be detected. It has been recognized that a similar concept is true for inorganic materials.

For instance, in conventional 3D printed objects, the walls of the 3D printed objects are filled significantly more than the interior compartments of the objects for structural reasons. This creates walls that are less permeable to water, allowing air to be trapped within the interior of the walls of the object depending on the design of the interior structure. For example, in the case of a hallow box, air may be trapped both inside the walls because the walls may not be solid as well as in the hollow void (cavity) inside the box. The air that is trapped within the walls themselves may be an issue because when 3D printing the structure, it is not a solid, fully filled medium but rather around 20% filled. The other 80% is filled with air. Thus, even if the object is provided from a material composition having an acoustic impedance that is the same as or substantially equal to the acoustic impedance of water, when the 3D printed objects are immersed in water, these objects generate a strong, and in some cases a very strong, impedance mismatch which results in a large acoustic signature primarily due to reflective property of the internally trapped air.

However, a strong impedance mismatch may not be desirable in many applications. For example, when used to hold or house a sonar device, the large acoustic signature generated by such plastic structures would increase the noise and feedback detected by the sonar device, thus reducing the sensitivity and functionality of the sonar interrogation. In another application, it may be desirable for a structure to avoid detection.

Concepts, structures, and techniques are disclosed for modifying the acoustic signature of plastic objects, such as 3D printed objects by forming or otherwise providing two or more openings or holes in walls of the plastic object. Such modification significantly reduces (and ideally eliminates) the acoustic signature produced by the plastic objects, thus enabling hiding, cloaking, and/or obfuscating of the plastic objects. In embodiments, two or more holes are created on the surface of a plastic object such that, when the plastic object is immersed in fluid, such as water, the interior of the plastic object becomes saturated with the fluid. In some embodiments, the holes penetrate through an exterior wall to the interior void or cavity of the plastic object.

As used herein, the term “object” refers broadly, in addition to its plain and ordinary meaning, to an article, item, component, device, structure, part, or any other thing that can be manufactured, seen, and/or touched. In embodiments, the object may be created or otherwise produced via 3D printing technology.

As used herein, the term “hole” refers broadly, in addition to its plain and ordinary meaning, to an opening through a solid body or surface. In this regard, a hole provides an opening though which fluid may flow from one side of the solid body or surface to the other side of the solid body or surface.

Although certain embodiments and/or examples are described herein in the context of 3D printed objects or structures, it will be appreciated in light of this disclosure that such embodiments and/or examples are not restricted as such, but are applicable to objects or structures in the general sense. For instance, the plastic objects and structures described herein may be manufactured or otherwise created using technologies and techniques other than 3D printing.

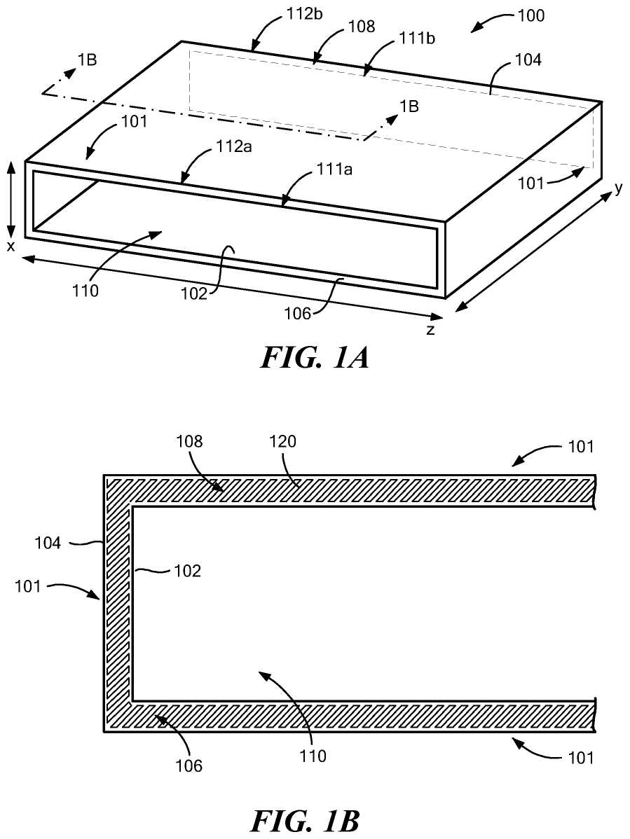

Referring now to FIGS. 1A, 1B in which like elements are provided having like reference designations, an example structure 100 having a modified acoustic signature may be formed or otherwise provided using an additive of subtractive process from a plastic material and/or metamaterial, such as materials including acrylonitrile butadiene styrene (ABS), acrylonitrile styrene acrylate (ASA), polylactic acid (PLA), and polyetherimide, to name a few examples. In embodiments, the material composition of structure 100 is selected to have or exhibit an acoustic impedance which is the same as or substantially similar to the acoustic impedance of water or saltwater. In embodiments, structure 100 may be configured to house or mount an underwater system or device, such as a sonar device.

As may be most clearly seen in FIG. 1B, walls 101 of structure 100 includes an inner wall 102 portion (also referred to herein as an inner shell 102 or inner surface of structure 100), and an outer wall 104 portion (also referred to herein as an outer shell 104 or outer surface of structure 100). Inner wall portion 102 includes a first edge 111a and a second edge 111b opposite first edge 111a, and outer wall portion 104 includes a first edge 112a and a second edge 112b opposite first edge 112a. Structure 100 also includes first and second (or upper and lower) wall members 106, 108. Upper wall member 106 joins first edge 111a of inner wall portion 102 to first edge 112a of outer wall portion 104, and lower wall member 108 joins second edge 111b of inner wall portion 102 to second edge 112b of outer wall portion 104. Inner wall portion 102 and outer wall portion 104, when joined by upper wall member 106 and lower wall member 108, form a sealed double-wall structure 101 having a wall cavity 120 (FIG. 1B). The wall cavity includes an infill structure 120 (FIG. 1B) which provides structure 100 having a sonar signature which is less than a sonar signature structure 100 would otherwise have if walls 101 were provided without the infill structure (e.g., if walls 101 of structure 100 were provided as solid or hollow walls). In embodiments, infill structure 120 may be configured to provide structural support to structure 100.

Upper wall member 106 joining the first edges of inner wall portion 102 and outer wall portion 104 defines an opening 110 extending into structure 100 toward the second edges of inner wall portion 102 and outer wall portion 104. In embodiments, lower wall member 108 joining the second edges of inner wall portion 102 and outer wall portion 104 may define an opening extending into structure 100.

FIG. 1B depicts a cross-sectional view of a portion of the double-wall structure of structure 100 taken across lines 1B-1B in FIG. 1A, in accordance with an embodiment of the present disclosure. As may be most clearly seen in FIG. 1B, channel infill structure 120 (sometimes referred to herein as a “wall cavity 120”) is disposed between the inner and outer shells 102, 104. Channel infill structure 120 may be provided as a high-density infill, such as, by way of example, about 30%-50%, or higher, within the wall cavity. Note that these percentages (e.g., percentages for determining high-density infill) can vary based on the infill design. For instance, if a more structurally sound infill, such as honeycomb, is used, then a lower infill percentage can be used for an equivalent strength of a higher density than a line infill. Such high-density infill structures may be appropriate for structural, extruded, or complicated structures. For example, channel infill structure 120 within the wall cavity of walls 101 may allow structure 100 to support a relatively large load.

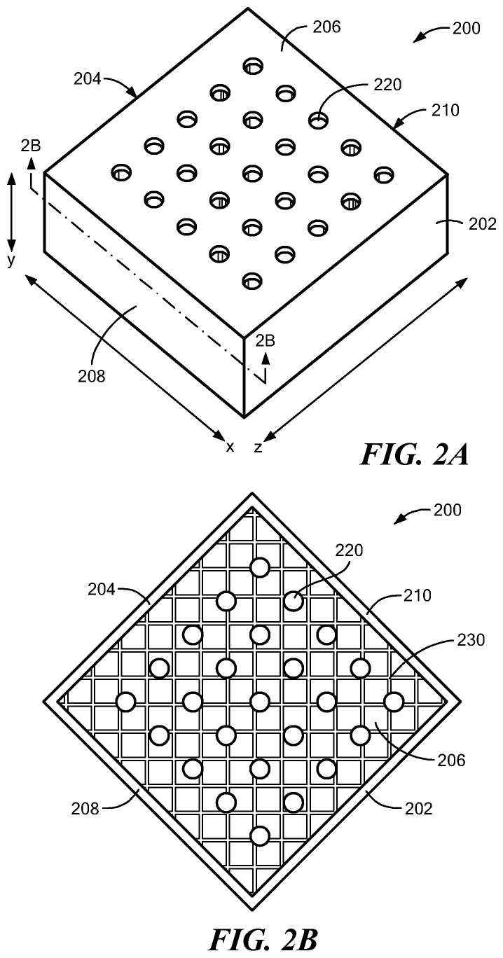

Referring now to FIGS. 2A, 2B in which like elements are provided having like reference designations throughout the several view, shown is an example structure 200 having a modified acoustic signature, in accordance with an embodiment of the present disclosure. In various respects, structure 200 may be similar to a portion of the double wall structure of structure 100 of FIG. 1A. For example, structure 200 may be configured to hold or mount (e.g., as a bracket) an underwater system or device, such as a sonar device.

Structure 200 has a rectangular box shape with an internal sealed cavity (not visible in FIG. 2A). Structure 200 includes a first or inner wall 202 forming an inner shell of structure 200, an outer wall 204 forming an outer shell of structure 200, a first side wall 208 forming a first side shell of structure 200, and a second side wall 210 forming a second side shell of structure 200. Structure 200 also includes an upper wall member 206 forming an upper shell of structure 200, and a lower wall member (not shown) forming a lower shell of structure 200. Inner wall 202, outer wall 204, first side wall 208, second side wall 210, upper wall member 206, and the lower wall member form the sealed cavity within inner wall 202, outer wall 204, first side wall 208, second side wall 210, upper wall member 206, and the lower wall member. The sealed cavity includes an infill structure (not visible in FIG. 2A).

Structure 200 also includes an arrangement or pattern of holes 220 (individually referred to herein as hole 220 or collectively referred to herein as holes 220) in upper wall member 206. Holes 220 provide an opening from an exterior of structure 200 to the sealed cavity of structure 200. Holes 220 allow the sealed cavity of structure 200 to be saturated with a fluid when structure 200 is immersed in the fluid. In embodiments, the number, diameter and arrangement of holes 220 may be based on factors such as the intended use of structure 200, the material composition of structure 200, thicknesses of the walls and/or wall members of structure 200, and the type of infill structure. In embodiments, the holes 220 need not have the same diameter (e.g., some, all or none of the holes may have the same diameter). Stated simply, the number, size, shape and position (i.e., location) of holes 220 are selected in accordance with a variety of factors including, but not limited to, the intended use of the structure, the material from which the walls are made, thicknesses of the walls and/or wall members of the structure, the type of infill structure, whether the structure is a structural component required to support or withstand a certain load and/or force and the specific design of the infill structure, and the shape of the structure. For instance, a structure that is arched shaped will typically have more are places where air could be trapped versus a box shaped structure. In general, a complicated the shape or a shape that diverges from simple 3D shapes, such as box, cylinder, sphere, etc., may require additional holes as compared to the simple 3D shapes in order to provide a convenient path for the water to enter and the air to escape.

For example, in the case where structure 200 is a structural component (in which case the walls may be relatively thick compared with the thickness of the walls in the case where structure 200 is a not a structural component), it may be desirable to use fewer holes having diameters which are relatively large compared with the number and/or diameter of holes in the case in which structure 200 is not being used as a structural component and the walls and wall members of structure 200 are likely to be relatively thin. In other words, as a relatively stronger component, structure 200 can support relatively larger size holes 220. As another example, if structure 200 is not being used as a structural component, the walls and wall members of structure 200 are likely to be relatively thin. In this case, a relatively larger number of holes 220 may be needed because the size of holes 220 may be smaller (i.e., relatively smaller size holes 220). The design of the infill structure may also affect the placement and arrangement of the holes.

FIG. 2B depicts a cross-sectional view of structure 200, in accordance with an embodiment of the present disclosure. In particular, FIG. 2B depicts a view that is along the y-axis looking up into the underside of upper wall member 206 through the sealed cavity of structure 200. As shown, structure 200 includes a lattice infill structure 220 within the sealed cavity. Lattice infill structure 220 may form a relatively large number of small compartments in the sealed cavity of structure 200. Accordingly, a larger number of holes 220 may be needed to saturate the sealed cavity with fluid.

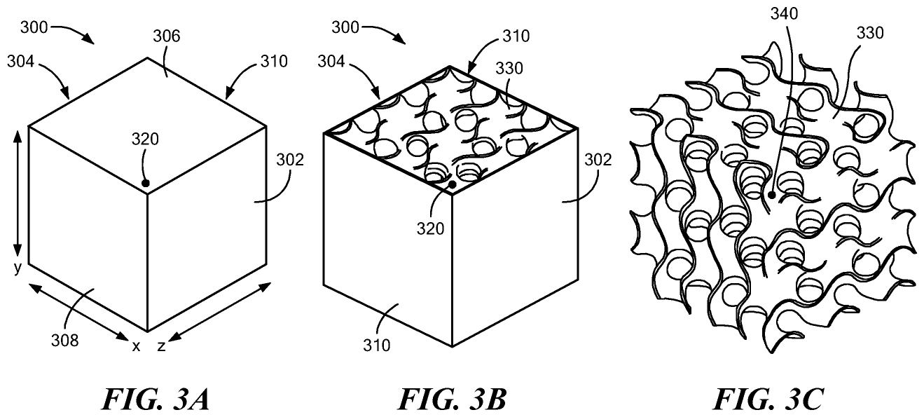

Referring now to FIGS. 3A-3C in which like elements are provided having like reference designations, shown is an example structure 300 having a gyroid infill structure 330 (FIGS. 3B, 3C) which provides structure 300 having a modified acoustic signature. In various respects, structure 300 may be similar to structure 200 of FIG. 2A. For example, similar to structure 200, structure 300 may be a portion of the double wall structure of structure 100 of FIG. 1A.

As shown, structure 300 is generally in the form of a cube or a square box and includes an inner wall 302 forming an inner shell of structure 300, an outer wall 304 forming an outer shell of structure 300, a first side wall 308 forming a first side shell of structure 300, and a second side wall 310 forming a second side shell of structure 300. Structure 300 also includes an upper wall member 306 forming an upper shell of structure 300, and a lower wall member (not shown) forming a lower shell of structure 300. Inner wall 302, outer wall 304, first side wall 308, second side wall 310, upper wall member 306, and the lower wall member form a sealed cavity within inner wall 302, outer wall 304, first side wall 308, second side wall 310, upper wall member 306, and the lower wall member. The sealed cavity includes an infill structure.

Structure 300 also includes a first hole 320 in upper wall member 306 and a second hole (not shown) in the lower wall member. First hole 320 is located toward the corner of inner wall 302 and second side wall 310. First hole 320 provides an opening from an exterior of structure 300 to the sealed cavity of structure 300. Similarly, the second hole may be located toward the corner of inner wall 302 and second side wall 310 and provide an opening from an exterior of structure 300 to the sealed cavity of structure 300. First hole 320 and the second hole being located at opposite sides (opposite ends) of structure 300 allow for efficient ingress of the fluid into structure 300 through one hole and egress of the air being displaced by the fluid out through the other hole. For example, if structure 300 shown in FIG. 3A is immersed in water, the water may enter through the second hole (not shown) in the lower wall member and the air may exit through first hole 320. In embodiments, first hole 320 only penetrates through upper wall member 306 to the sealed cavity, and the second hole only penetrates through the lower wall member to the sealed cavity. First hole 320 and the second hole in the lower wall member allow the sealed cavity of structure 300 to be saturated with a fluid when structure 300 is immersed in the fluid.

FIG. 3B depicts a perspective view of structure 300 having upper wall member 306 removed to reveal structures which would otherwise not be visible. As shown, structure 300 includes a gyroid infill structure 330 within the sealed cavity. Gyroid infill structure 330 provides an organic open cell structure that exhibits high strength properties at relatively low densities. Gyroid infill structure 330 also exhibits relatively good permeability to fluids such as liquids such as water. Additionally, as the inner voids of gyroid infill structure 330 are interconnected, a relatively smaller number of holes as compared to other infill structures may be sufficient to saturate the sealed cavity. As such, first hole 320 and the second hole (not shown) may be sufficient to saturate the sealed cavity with a fluid.

FIG. 3C depicts a portion of gyroid infill structure 330, in accordance with an embodiment of the present disclosure. As shown, gyroid infill structure 330 includes a hole 340 located at about the center of gyroid infill structure 330. Hole 330 penetrates into at least the upper portion of gyroid infill structure 330. Hole 330 may also allow for saturation of the sealed cavity with fluid.

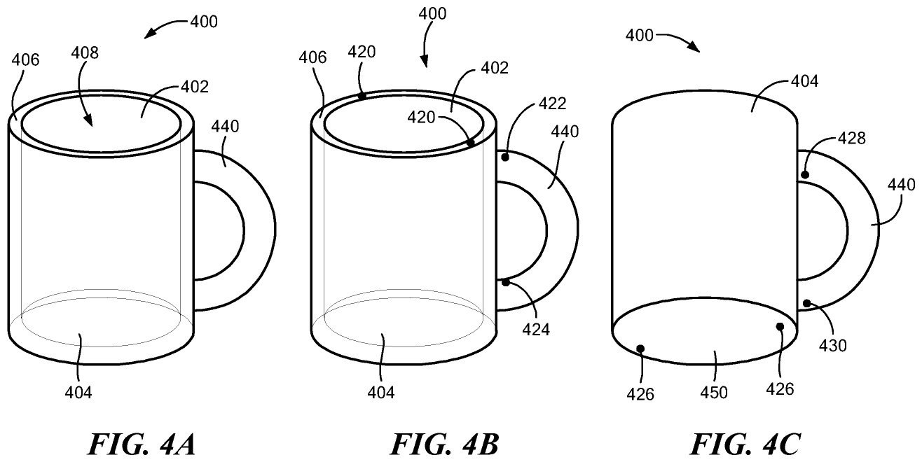

FIG. 4A depicts a perspective view of an example cylindrical structure 400 having a modified acoustic signature, in accordance with an embodiment of the present disclosure. As shown, structure 400 includes an inner wall 402 forming an inner shell of structure 400, and an outer wall 404 forming an outer shell of structure 400. Structure 400 also includes an upper wall member 406 and a lower wall member (not visible in FIG. 4A). Upper wall member 406 joins inner wall 402 to outer wall 404 at one end of inner wall 402 and outer wall 404, and the lower wall member joins inner wall 402 to outer wall 404 at an end of inner wall 402 and outer wall 404 opposite upper wall member 406. Inner wall 402 and outer wall 404, when joined by upper wall member 406 and the lower wall member, form a sealed double-wall structure having a wall cavity (not shown). The wall cavity includes an infill structure (not shown).

Upper wall member 406 joining inner wall 402 and outer wall 404 defines an opening 408 extending into structure 400. Opening 408 may receive fluid, for example, when structure 400 is immersed in fluid. Structure 400 also includes an extruded portion 400 attached to the outer shell of structure 400. As shown, extruded portion 440 is generally in the form of a curved pipe structure, where opposing ends of the pipe structure are attached to the outer shell of structure 400. Similar to structure 400, extruded portion 440 may include a double wall structure having a wall cavity (not shown).

FIG. 4B depicts a perspective view of structure 400 with additional details. As shown in FIG. 4B, structure 400 includes holes 420 opening in upper wall member 406. Structure 400 also includes a hole 422 in an upper surface of an upper portion of extruded portion 440, and a hole 424 in an upper surface of a lower portion of extruded portion 440.

FIG. 4C depicts a perspective view from the bottom of structure 400 with additional details. As shown in FIG. 4C, structure 400 includes holes 426 in a lower wall member 450. In embodiments, lower wall member 450 may seal an opening defined by the second edges of inner wall 402 and outer wall 404. In other embodiments, lower wall member may include an opening extending into structure 400. Structure 400 also includes a hole 426 in a lower surface of the upper portion of extruded portion 440, and a hole 430 in lower surface of the lower portion of extruded portion 440.

Still referring to FIGS. 4B and 4C, holes 420 and holes 426 are substantially aligned. In other words, each of holes 420 is located substantially opposite a respective hole 426. Similarly, hole 422 is substantially aligned with hole 428, and hole 424 is substantially aligned with hole 430. In other words, hole 422 is located substantially opposite hole 428, and hole 424 is located substantially opposite hole 430. Locating the holes in this manner may increase (and ideally maximize) penetration into the structure while reducing (and ideally minimize) the number of holes needed to saturate the cavity of the structure. For example, when structure 400 is immersed in fluid, the fluid may flow in through holes 426, 428, 430 to the cavities of structure 400 and extruded portion 440, and the air in the cavities of structure 400 and extruded portion 440 may flow out (i.e., release) through holes 420, 422, 424.

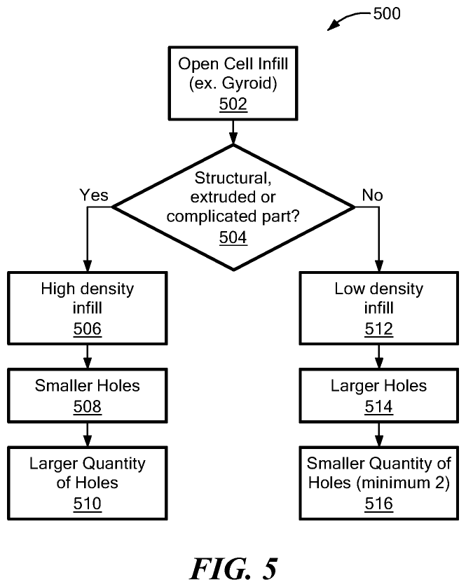

FIG. 5 is a flow diagram of an example process 500 for determining hole placement in a structure, in accordance with an embodiment of the present disclosure. For example, process 500, may be implemented or used within a component manufacturing process, such as a 3D printing process. Rectangular and hexagonal elements are herein denoted “processing blocks,” and represent computer software instructions or groups of instructions. Alternatively, the processing blocks may represent steps or processes performed by functionally equivalent circuits such as a digital signal processor circuit or an application specific integrated circuit (ASIC). The flow diagram does not depict the syntax of any particular programming language, but rather illustrates the functional information one of ordinary skill in the art requires to fabricate circuits or to generate computer software to perform the processing described. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered, meaning that, when possible, the functions represented by the blocks can be performed in any convenient or desirable order.

With reference to FIG. 5, example process 500 commences at block 502, where it may be determined that a structure being produced includes one or more walls having an open cell infill (e.g., a gyroid infill structure). For example, the determination of the type of infill may depend on the type of structure being produced. In any case, an open cell infill, such as a gyroid, may allow for reducing the number of holes needed to saturate the sealed cavity or cavities. For instance, use of a non-open cell infill, such as triangles, may require holes that enter very triangle to saturate the sealed cavities and, thus, require a significantly larger number of holes that in the case of an open cell infill.

At block 504, a determination as to whether the structure being made is a structural, extruded, or complicated part. Here, a complicated part may be a part that is in a shape other than what are generally considered simple 3D shapes, such as box, cylinder, and sphere, to provide some examples. If it is determined that the structure is a structural, extruded, or complicated part, then, at block 506, it is determined to use a high-density (e.g., 30%-50%) infill of the open cell infill structure.

At block 508, it is determined to create relatively smaller sized holes in the structure. At block 510, it is determined to create a relatively larger quantity, minimum of two (2), of the smaller sized holes in the structure.

Otherwise, if it is determined that the structure is not a structural, extruded, or complicated part, then, at block 512, it is determined to use a low-density (e.g., 10%-15%) infill of the open cell infill structure.

At block 514, it is determined to create relatively larger sized holes in the structure. At block 516, it is determined to create a relatively smaller quantity of the larger sized holes in the structure. In embodiments, a minimum of two larger sized holes may be created in the structure.

In some embodiments, the different processes, methods, and techniques described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety

What is claimed is:

1. A structure comprising:
at least one wall comprising:
an inner wall forming an inner shell of the structure, the inner wall having a first edge and a second edge opposing the first edge;
an outer wall forming an outer shell of the structure, the outer wall having a first edge and a second edge opposing the first edge;
an upper wall member joining the first edge of the inner wall to the first edge of the outer wall and a lower wall member joining the second edge of the inner wall to the second edge of the outer wall to form a wall cavity; and
an infill structure within the wall cavity.

2. The structure of claim 1, wherein the infill structure within the wall cavity provides the structure having a desired sonar signature.

3. The structure of claim 1, wherein the infill structure within the wall cavity provides the structure having a sonar signature which is reduced compared with the sonar signature of a comparable structure having the same size and shape and having solid or hollow walls.

4. The structure of claim 1, wherein the structure comprises a plurality of walls with each of the walls comprising:
an inner wall forming an inner shell of the structure, the inner wall having a first edge and a second edge opposing the first edge;
an outer wall forming an outer shell of the structure, the outer wall having a first edge and a second edge opposing the first edge;
an upper wall member joining the first edge of the inner wall to the first edge of the outer wall and a lower wall member joining the second edge of the inner wall to the second edge of the outer wall to form a wall cavity; and
an infill structure within the wall cavity.

5. The structure of claim 1, wherein the structure is provided having at least two holes extending from an exterior of the structure to the wall cavity.

6. The structure of claim 1, wherein the structure is formed of a plastic material.

7. The structure of claim 1, wherein the structure is formed of a material having an acoustic impedance substantially similar to acoustic impedance of a fluid into which the structure is to be submerged.

8. The structure of claim 7, wherein the material includes acrylonitrile butadiene styrene (ABS).

9. The structure of claim 7, wherein the material includes acrylonitrile styrene acrylate (ASA).

10. The structure of claim 7, wherein the material includes polylactic acid (PLA).

11. The structure of claim 7, wherein the material includes polyetherimide.

12. The structure of claim 1, wherein the infill structure includes a gyroid structure.

13. The structure of claim 1, wherein the infill structure includes a lattice structure.

14. The structure of claim 1, wherein the infill structure includes a channel structure.

15. The structure of claim 1, wherein the infill structure includes a honeycomb structure.

16. The structure of claim 5, wherein the at least two holes are of a plurality of holes.

17. The structure of claim 5, wherein at least one hole of the at least two holes is in the upper wall member.

18. The structure of claim 5, wherein at least one hole of the at least two holes is in the lower wall member.

19. The structure of claim 1, further comprising an extruded portion extending from the outer wall of the structure, the extruded portion having a cavity and an infill structure within the cavity.

20. The structure of claim 19, further comprising at least two holes in the extruded portion providing an opening from an exterior of the extruded portion to the cavity of the exterior portion.

21. The structure of claim 1, wherein the structure is a cylindrical structure having a base member sealing the second edge of the inner wall and forming a base of the cylindrical structure.

22. The structure of claim 1, wherein the structure is a 3D printed object.
